(19) United States
(12) Patent Application Publication
(10) Pub. No.: US 2005/0278258 A1
(43) Pub. Date: Dec. 15, 2005

(54) User software for facilitating copyright licensing and compliance

(76) Inventors: Michael O'Donnell, Issaquah, WA (US); Jonathan Peterson, Chicago, IL (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/867,831

(22) Filed: Jun. 14, 2004

(51) Int. Cl. G06F 17/60

(52) U.S. Cl. 705/59

(57) ABSTRACT

A computer program for use on a user computing device with access to a computer network in conjunction with a rendering program that can present to a user a work of authorship. The work of authorship may be visual, auditory, musical, textual, graphical or any combination. The rendering program can be any program that renders a work of authorship retrieved from across the network, such as a standard browser. The computer program can be a plug-in. The computer program cues the user to a work that is available for licensing by searching the work for an identification which it sends to a server to look up licensing availability. By also sending an identifier of the computer program, it can determine whether a site license has been granted for that work for that user. It can track uses of each work by the user and report them to copyright managers.

### FIELD OF INVENTION

This invention addresses the problem of how to easily access information about the owner or authorized publisher of a work of authorship, as well as the licensing information or use terms established by that copyright owner or publisher. In addition, the invention addresses the problem of how companies or organizations can simply receive licenses for their employees' reuse of any number of works under a blanket (bulk) site license agreement, and how individuals can quickly receive per-use licenses to any number of works. The invention also provides a mechanism for any user to request a fee-based license or free permission to use any work that was created or published by another that resides in digital form.

### BACKGROUND

All forms of human expression that can be recorded in a tangible medium are protected by copyright as “works of authorship”. The possible media of expression include text, two-dimensional static visual images, moving visual images, three-dimensional sculptures, music recorded with visual graphics, music recorded in digital pitch specifications, music recorded as soundwaves, and soundwave recordings of spoken words. This list is not exhaustive as new forms are continually being invented. The author of such a work is typically the owner of the copyright on a work, but these rights can be transferred to other entities, often the publisher of the work. For the purpose of this application, the term “copyright owner” is used interchangeably with the terms “rights holder” and “publisher”.

When a party who does not own the copyrights in a work of authorship wishes to make a second use of that work of authorship—other than merely view, read, or listen to the work—a license from the owner is generally required. As used in this application, the word “license” shall also mean “right,” “clearance,” and “permission.” The copyright owners generally are willing to allow their works to be used in exchange for a fee, or sometimes for free as long as permission is obtained and attribution given to the copyright owner or publisher. Copyright clearinghouses have been established for various kinds of works of authorship so that standing offers of licenses from the owners of copyrights can be assembled in one place from which they can easily be retrieved and accepted. Typically, the clearinghouses also process and enforce the payment of fees by those who accept the offered licenses and distribute the fees to those who are entitled to them. Using labor intensive methods, the clearinghouses generally track all of this information using paper and computer databases and they handle communications with owners of copyrights, with their distribution agents, and with licensees, in person, by telephone, by fax, and by e-mail. Copyright clearinghouses also use a central repository system whereby users can access a database of works that the clearinghouses have the rights to grant licenses to.

The Internet has presented serious challenges to the established copyright clearance systems. Many forms of works of authorship are now published digitally on the Internet, including text, audio recordings, digital music, still images, and videos. When these works of authorship are received by a client computer on the Internet, a copy can very easily be made on the client computer. The copy can then be reproduced, distributed, performed, displayed, or used to prepare a derivative work. Although it is very easy for an internet user to make such uses of source works of authorship, it is often very difficult to locate the owners of copyrights in these works or their agents and obtain licenses in a timely manner. Furthermore, even if the process of requesting and obtaining a license were made easier and more timely by each copyright owner, a user would have to deal with hundreds if not thousands of different copyright owners in order to use the many works that a user may want to use over a given time period. Furthermore, a work of authorship may be a compilation of several works, each having different authors and requiring different rights. For example, a news article on a web site may contain a story, a photograph, several charts and graphs, and a streaming video clip. Each of these individual works may be owned by different authors, each requiring a different type of license. A user would have to go through the process of locating each rights holder and obtaining a license from each, in order to use the compiled work.

Inventors have attempted to solve this problem by presenting technical means to prevent or discourage unauthorized use of works of authorship. These methods include using public key encryption to verify certificates of authority, which are attached to works of authorship to prove that licenses have been obtained; methods of applying watermarks to a digital work of authorship to trace the reuse of a work; requiring specific versions of client applications to enforce licensing restrictions bundled into files; and so on. Furthermore, copyright clearinghouses and author agents have attempted to solve this problem by standardizing and centralizing the licensing process. These methods have inherent shortcomings from the perspective of both copyright owners (licensors) and users (licensees), which the invention overcomes.

### SUMMARY OF THE INVENTION

Rather than forcing the user to contact the copyright owner or clearinghouse, or have to access a central repository of works to see if the work desired is covered and what the licensing terms and procedures are, the invention uses a distributed licensing method. This method automatically grants a license, or allows the user to request a license, at the user's point of contact with the work of authorship. To accomplish this, the invention uses three components: 1) a tag or series of tags, such as a Digital Object Identifier (DOI), Publisher Registered Content (PRC) tag, story ID tag, or another tag that uniquely identifies and is attached to the work, 2) a software program, herein called a “plug-in”, that is installed on the user's access device that can search for, locate, and act upon one or more tags, depending upon what version of the plug-in the user has installed and how it has been configured, and 3) a database of ownership and/or licensing information, terms and procedures maintained by copyright owners or their agents.

In one aspect, the invention provides a simple way for creators and publishers of works of authorship who affix tags to their works to allow those tags to be used to extend licenses to their works. The tag may be invisible to the user, or may be visibly rendered in the form of an icon or text link. When “read” by the plug-in, the tag identifies the owner and the owner's rights and, in cooperation with an automated licensing agent that accesses a database of licensing terms, offers licenses on a one-off (individual) basis, or provides an automatic license under a separate site license agreement, or offers a mixture of the two, all depending upon what version of the plug-in is installed on the client device and how it has been configured.

In another aspect, the invention provides a simple way for users, operating system providers, and makers of devices that can access digital content (such as PC's and PDAs), to install a software plug-in that facilitates copyright licensing and compliance. The plug-in is rendered as an icon or text link (hotspot) in the user's web browser, on the user's desktop, or within any other convenient location. When activated by click, touch, voice command or other mechanism, the plug-in locates the tags within the work of authorship currently being accessed by the user to automatically grant a license or to allow the user to obtain a license by completing certain steps. The invention also makes it possible for different types of users, such as corporate users, educational users, non-profit users, and government users, to obtain different types of licenses at different terms and rates, or to request a license, based on what version of the plug-in they have installed and how it has been configured. The idea of making plug-ins available to different types of users, configured properly, which can “read” unique tags affixed to or embedded within works of authorship, is central to this aspect of the invention. The plug-ins communicate with one or more databases of licensing rules, prices, and procedures, so that changes do not require new installations of the plug-ins. Each plug-in can cover a different set of works of authorship and grant an automatic “site” or “bulk” license for all works, or require each work to be licensed separately.

In another aspect, the invention is a method of providing a visual or verbal cue to the user that a work being accessed by the user is copyrighted and that the work is available to be licensed, or is already covered under a site license. For example, when a user accesses a web page and the web page contains the tags, the icon installed in the user's browser might change color, or a chime might play from the user's computer speaker, or a pre-recorded or synthesized voice might play an alert. The user can then click on the icon to access general information about the copyright owner of the work and to obtain a license to reuse it. Depending upon the version of the plug-in the user has installed and how it has been configured, the user may automatically be granted the rights to use the work according to a site license agreement pre-established with the copyright owner or his agent, or might be offered different terms from the copyright owner. In this respect, some works will be pre-authorized by the copyright owner and may be automatically used because the user has purchased a site license to a collection of works. Other works may not be pre-authorized for automatic licensing and will require the user to choose from several individual-licensing options, or to request a one-off license.

In another aspect, the invention is a method for copyright owners or their authorized agents to grant institutional users wholesale rights to all of the works published by the copyright holder for one annual fee. This is a convenient method for companies that may have thousands, or tens of thousands, of employees who are accessing the Internet and downloading content every day. These companies must comply with the Digital Millennium Copyright Act, which provides for statutory penalties of $150,000 or more for each instance of infringement. Publishers find it impractical and cost prohibitive to monitor how institutional users are using their content. Institutional users find it difficult to ensure their employees are not infringing copyrights. The invention provides a better mechanism for publishers to extend a blanket (bulk) site license to institutional users of content and to monitor that usage to ensure compliance with the terms of the license extended. To enable automatic licensing or one-off licensing of their content to institutional users or individuals, publishers need only to embed the aforementioned tags in their content, and link those tags to a database maintained by themselves or their authorized licensing agent. For their part, to be covered by a site license, an institutional user needs only to execute a site license agreement with the publisher or publisher's agent, and install an appropriately configured plug-in on each employee's computer, cell phone, digital file reader, digital file player, PDA, or other device that is used to access digital content. The plug-in can read the tags to let institutional users know whether or not the content accessed is covered by their site license.

In another aspect, the invention is a method for all users of content, whether they are covered by a site license or not, to request a license if reuse rights are not automatically available. By installing and configuring the plug-in, users can instantly tell whether the work is available to be licensed when they access it. If the work does not contain tags and thus no information about the copyright owner or licensing terms is immediately available, the invention provides a mechanism for users to request a license. All requests are routed to a central clearinghouse or directly to the copyright owner if third party tags are available. If it is routed to a clearinghouse, a clearinghouse employee will attempt to track down the owner of the work and obtain permission for the user.

In another aspect, the invention is a method for tracking and compensating different parties in the content aggregation, hosting, and distribution chain. Each party that touches a publisher's content can add a tag if a suitable tag is not already affixed to the content, with permission from that publisher. If a tag is already affixed to the content, the party can extend the tag with their unique identifier, before they publish it, put it in a database, or distribute it to others. For example, Forbes magazine may tag their content before they distribute it to Lexis-Nexis. Lexis-Nexis may then add their unique assigned identifier to the tag and distribute it to Boeing. If Boeing is using the software plug-in component of the invention, both Forbes and Lexis-Nexis can share the revenue, whether that revenue is from a site license or a one-off (individual) license. There are no limits to how many times the tag can be extended to provide for multiple parties in the content creation, production, and distribution chain.

In another aspect, the invention is a method of delineating and compensating different rights holders of a compiled work. A work of authorship accessed by a device may contain multiple works of authorship (for example a page displaying an article, several photos, a graphic, and a musical composition, all of which being separate works of authorship). Consequently, the work may contain one or more licensing tags for the invention to take advantage of. One tag may grant rights and permissions to the text, another tag to the photograph and/or graphic, and a third tag to the musical composition. Different parties may own different tags and the process by which they are affixed to a work. If multiple licensing links are discovered, the visual appearance of the plug-in might change to indicate multiple choices. One tag may also cover all of the respective individual works contained within the complied work. Using the invention, a user can obtain permission for one or more of the individual works contained within a compiled work, or to the full compiled work.

In another aspect, the invention is a method for tracking, monitoring, reporting, and enforcing copyright compliance of tagged content that is created, distributed, and consumed. The tags and the plug-in, in cooperation with the database of copyright owner information and licensing terms, allow reports to be provided to creators, publishers, distributors and users. The invention allows publishers to see how much of their content was viewed by an individual or site license buyer. If their content is being viewed by site license buyers, the publisher can see what type of user is using their content, i.e., a marketing person, an executive, and/or an administrative employee if this information is customized into each plug-in. The invention can also report what types of reuses individual buyers and site license buyers received a license for. For example, a publisher can see how much of their content was printed, copied, e-mailed, or posted on the user's Intranet. The same types of reports can be provided to the individual buyer or site license buyer. Using the invention, a corporate site license buyer, for example, can see what content was consumed by the company's employees, how much was consumed, and how it was consumed. This helps the corporation monitor content usage by employees and by functional departments, while keeping the entire company in compliance with copyright laws.

### BRIEF DESCRIPTION OF THE DRAWINGS

The features of the present invention which are believed to be novel are set forth with particularity in the detailed description and claims. Aspects of the invention, together with further objects and advantages thereof, may best be understood by making reference to the following description taken in conjunction with the accompanying drawings wherein:

FIG. 1 shows how the invention is implemented through servers, databases, data, and software components.

FIG. 2 shows a flow diagram.

### DETAILED DESCRIPTION

In the following detailed description of exemplary embodiments of the invention, reference is made to the accompanying drawings. The detailed description and the drawings illustrate specific exemplary embodiments by which the invention may be practiced. Other embodiments may be utilized, and other changes may be made, without departing from the spirit or scope of the present invention. The following detailed description is therefore not to be taken in a limiting sense, and the scope of the present invention is defined by the stated claims.

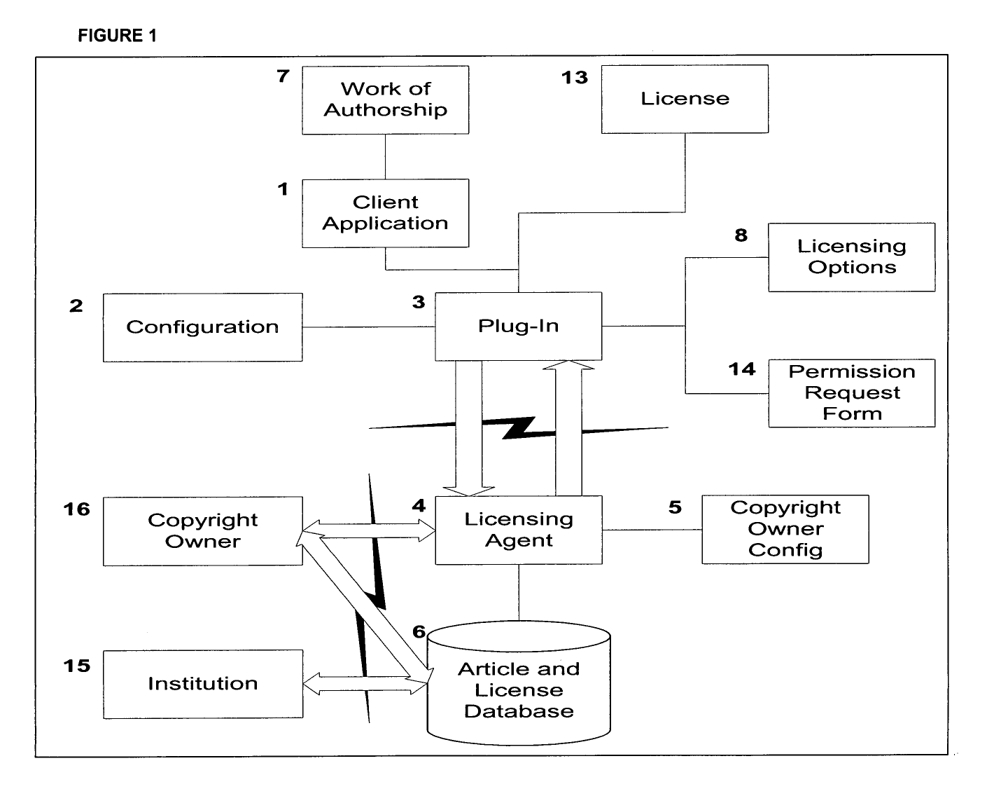

The invention is implemented through servers, databases, data, and software components as shown in FIG. 1.

Each work of authorship 7 that is available for licensing is “tagged” with a unique work identifier. This identifier, which will be referred to as a licensing tag henceforth, identifies such information as the copyright owner, the work of authorship, and the licensing agent that has authority to issue licenses to users on behalf of the content owner. Other information can be identified in the licensing tag—to offer additional functionality, to optimize behavior, or for any other reason. For example, one such licensing tag is used by Data Depth Corporation's Instant Clearance Service, and which has the following basic format:
http://www.rsicopyright.com/A.B?C

In this example, the HTTP address specifies the licensing agent, RSiCopyright of St. Paul, Minn. A is the series identifier, which determines how subsequent fields are interpreted. B? (any number of characters) is the unique identifier for a copyright owner. The combination of A and B allow for the interpretation of C, which uniquely identifies the work of authorship within the corpus of works owned by B. This information, including other information about the copyright owner B that is stored in a database and configuration files at the licensing agent's servers, allows the licensing agent to determine whether a work of authorship can be offered for license, and under what terms, to what users. Different licensing agents may choose to implement this process in different ways.

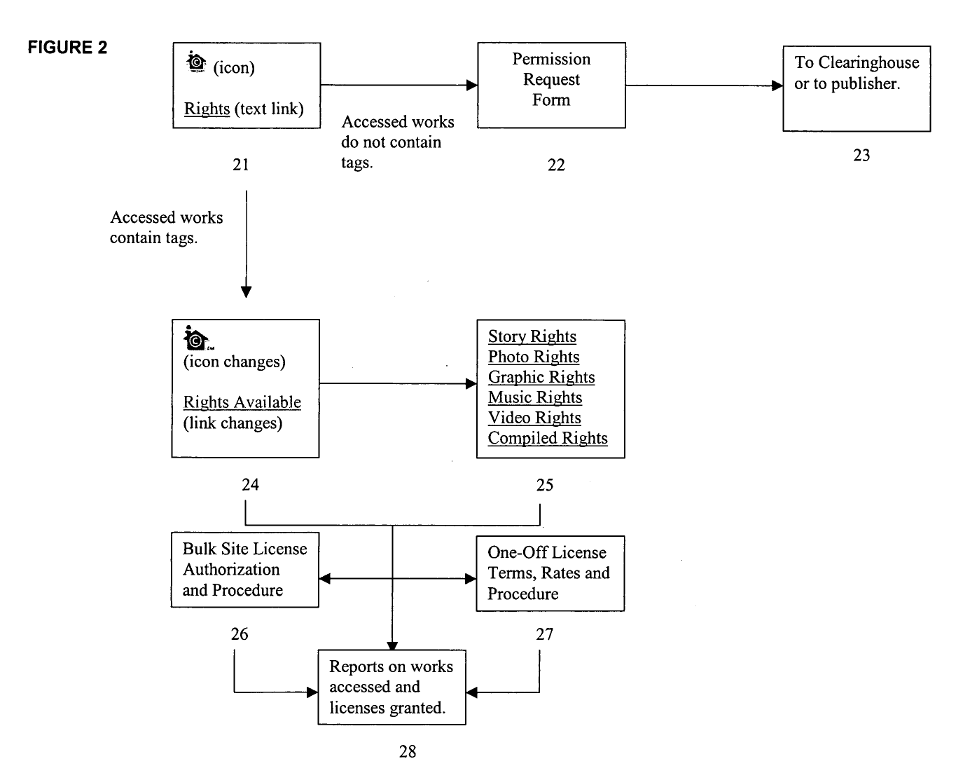

The licensing tag is associated with the work of authorship 7 itself, either embedded in metadata appropriate to the work's format, or attached in human-readable form, or both. Depending on the work of authorship and the client application used to view it, this tag may be invisible to the user, or may be rendered by the client viewing application 1 (see FIG. 2). For example, a document displayed in a web browser may contain a hyperlink (also known as an anchor or a hot spot) which, when clicked, directs the user browser program to a web page or a series of web pages, hosted by the licensing agent, which provides licensing information related to that work and allow the user to obtain a license respecting the business rules offered by the copyright owner.

A document displayed by the client viewing application 1 may contain multiple works of authorship. For example, a web page displayed by a browser might contain an article, several photos, and a graph, each of which is a separate work of authorship. Consequently, a document may contain one or more licensing tags. Every licensing tag in a work of authorship can refer to the same work of authorship, or to different ones (for example, one licensing link for each individual work of authorship in the document). Each separate work of authorship in a document may be owned by a different copyright owner, and each might be handled by a different licensing agent. A work of authorship might not be displayed in its entirety by the client application, or it might be displayed in a way specific to the client application (for example, an article found on the web might be split into more than one web page, or a digital photograph might be displayed in a lower resolution for display in a cell phone window). In all cases, regardless of the location or appearance or number of the licensing tags, each can be used to uniquely identify a work of authorship to be licensed and identify how the work was distributed.

A software component, called a plug-in 3, can be installed on a client application in order to facilitate the licensing of works of authorship. As part of the installation process, the plug-in may be configured to identify the user of the plug-in to licensing agents. This configuration information 2 might include, but is not limited to, such information as: the name of the user, his mailing address, his email address, his phone number, the institution for which he works, his department, his section, user credentials such as username and password, and so on. Some of this configuration information can be changed at will by the user, and some of it may be encrypted and impossible for a user to change. Some of this configuration information might be preloaded. For example, a licensing agent may provide an institution with a specific version of a plug-in that identifies the plug-in as being owned by that institution, as part of a site license agreement. This configuration information is stored in a location appropriate to the client application and the required security constraints, for example on a computer's hard disk associated with a particular login, or on an institution's computer network, or burned into the firmware of an embedded device. Furthermore, there can be many versions of a plug-in available for a single client application, for different categories or populations of users.

The plug-in 3 modifies the behavior of the client application 1. It searches for licensing tags associated with a document whenever a new document is loaded, or when requested by the user, or when triggered by some other external event. It searches for these tags using whatever mechanism is appropriate for the format of the work of authorship that the client application is designed to view. For example, a plug-in for a web browser might check a web page's Document Object Model for a licensing tag in the metadata section, or might scan the body of the content for a licensing tag in an appropriately formatted comment block. A plug-in for a music player might look in the ID3 comment tags of a music file.

For each unique licensing tag found by the plug-in, the plug-in initiates a request to a licensing agent specified by that tag, in order to determine the licensing options available to that particular user. These queries are normally made in the background, and concurrently where practical. A request to the licensing agent's servers 4 includes, but is not limited to, such information as the unique work identifier and the plug-in's configuration information. This request is normally sent encrypted over the internet, using whatever protocol is appropriate to the client application, but it may adopt some other communication mechanism where appropriate.

The licensing agent's servers 4 use the fields of the unique work identifier, in particular the copyright owner identifier and the identifier for that particular work within the set of works owned by the copyright owner, to look up configuration information about the copyright owner 5 and the licensing terms for that article in its article and license database 6. The copyright owner configuration and the article and license database may be the same physical database, or separate databases, on a single server or several servers. These licensing terms can include, but are not limited to, such information as: the name of the work, the authors of the work, the copyright notice, the legal terms of use, the prices and options available for licensing, and so on. The licensing agent's server then cross-references this information with the plug-in's configuration information from the request to determine under what conditions the work of authorship is available for licensing, if at all, to that particular user. For example, a copyright owner might offer a license to a work of authorship under different terms if the configuration information specifies that the user works for a non-for-profit organization, as opposed to a commercial institution, or an institution that has a site license with the copyright owner as opposed to a non-aligned institution. The information that the licensing agent sends back in response to the plug-in's request therefore includes, but is not limited to, such information as: if the work is covered by a site license for that user, if the work must be individually licensed, in what ways the work can be licensed (such as printed, photocopied, emailed, or what have you), what fees (if any) will be charged, and so on.

When all the results have been acquired by the plug-in, it makes this known to the user, for example through changing its appearance, sounding a chime, or any other mechanism. Thus the user is quickly informed whether a work of authorship is easily licensed through the software. The plug-in also provides an appropriate selection of choices for the user to license the content, depending on the results obtained from the licensing agent's server, the number of the licensing tags, and the client application. For example, a web browser plug-in might display a button with an icon and text. If a loaded document contains no licensing tags, the logo might be black and read “Request Permission From an Agent.” If the plug-in determines that the user is covered by a site license for the particular document, the logo might be green and the text might read “Use Instantly.” If the plug-in determines that the user is not covered by a site license, but that the work of authorship can be licensed under terms specified by the copyright owner, the logo might be yellow and the text read “Request a License.” If there is more than one licensing tag in a document, the plug-in might render a drop-down box containing unique identifiers, or offer a choice in some other way. It is expected that different client applications running on different devices will render these options to the user in different ways.

If the user elects to license a work of authorship referenced by a licensing tag, either through a site license or an individual license, then the user activates the plug-in through a button click, touch, voice command, or other mechanism appropriate to the client application. The user is then presented by the plug-in with licensing options 8 as returned by the licensing agent. As we have seen, these options are particular to the work of authorship, the user as described by the plug-in's configuration options, and business rules located in the copyright owner configuration file.

Should the user, after examining the licensing options, choose to license the work of authorship, then the plug-in collects whatever other information is required of the user in order to license the content. For example, a license to host a work of authorship on a third-party website might require identification of that site; a fee-based license might require the entry of credit card information; and so on. When all required information has been collected by the plug-in, a request to license the content is sent to the licensing agent's server on behalf of the user. This request includes but is not limited to such information as: the unique work identifier, the plug-in's configuration information, the type of license being requested (permission to photocopy, or to include in a newsletter, for example), payment options if appropriate, and so on. This request is normally sent encrypted over the internet, using whatever protocol is appropriate to the client application, but it may adopt some other communication mechanism where appropriate.

On receipt of the request, the licensing agent's server uses the fields of the unique work identifier, in particular the copyright owner identifier and the identifier for that particular work within the set of works owned by the copyright owner, to look Lip configuration information about the copyright owner 5 and the licensing terms for that article in its article and license database 6. It verifies that the terms and conditions as specified for the work of authorship are met, that the required information has been collected by the plug-in, that the payment can be collected, and so on. If all the requirements are met, the licensing agent's server then creates a record for a license for the intended use and stores that information in the article and license database 6. The information that is stored in this database about the license includes, but is not limited to, such information as the user who requested the license, the time of license, the intended use of the license, the work of authorship being licensed, any information found in the plug-in configuration, and similar information. As part of recording this information in the license database, a unique license number (or other identifier) is generated.

The generated license number, along with other information about the license just purchased, is returned to the plug-in. The plug-in can then display the terms of the license 13 to the user, may change color or text, or use any other method of communication with the user appropriate to the client application.

Of course, it is possible that the client application will be used to view a work of authorship which does not have any licensing tags of the form described above embedded in it. In this case, the plug-in can still be activated, either by clicking, touching, voice activation, or any other mechanism appropriate to the client application, in order to simplify the licensing process. When activated in this state, the plug-in collects information about the work of authorship from the user via a Permission Request Form 14, including but not limited to such information as: the user requesting the reuse, the work of authorship being licensed, the type of license desired, the user's budget, and so on. The fields regarding the work of authorship may be filled in automatically by the plug-in by parsing content metadata appropriate to the format of the work of authorship, depending on the work of authorship and the client application. The Permission Request Form may collect and forward to the appropriate parties the following types of information:
Information about the work, such as the name or title of the work, a description of the work, the name of the author/publisher, and the URL of the work. Depending upon what version of the plug-in the user has installed, and how it has been configured, some or all of this data may be collected automatically by the plug-in software. When the hotspot is activated, the plug-in attempts to read the metadata within the work of authorship. For example it may read HTML metatags or Digital Object Identifiers (DOIs) for written content on the web, ID3 tags on MP3 music files, or any other tags embedded in the works by the publisher or third party systems. These metatags may enable the plug-in software to capture information about the work. The user can manually fill in whatever information can not be automatically captured by the plug-in.
Information about the user, or requester, such as Name, Title, Organization, Street Address, City, State, Zip, Phone, Fax, E-mail Address, and Web Site URL. Depending upon what version of the plug-in the user has installed, and how it has been configured, the user may have to fill-in these fields manually, or the form may populate itself with this information. The data about the user may reside locally on the user's device, or may be supplied by a server hosted by the user's employer or by a clearinghouse.
Information about the type of license desired. The plug-in provides preset options that the user can choose from. These may include excerpt, photocopies, e-mail distribution, custom reprints, framing, linking, republication, posting on an Intranet or Internet, or other kinds of licenses. If the type of license desired by the user is not listed, the user may fill in one or more blank text fields to describe the type of use he wants to make of the work.
Information about the user's budget, price range, or offer. The Permission Request Form provides fields that the user can use to enter a budget, price range, or offer to license the work of authorship. The user may, for example, specify a price he is willing to pay or request that permission to use the content be granted free of charge

On completion of the Permission Request Form 14, the plug-in gathers all the appropriate information and forwards it on to the appropriate licensing agent via a network request. The selection of the appropriate licensing agent can be specified in the plug-in's configuration, or in metadata in the work of authorship, or can be chosen by the user, or can be selected any other mechanism. Whether the permission request is sent to a clearinghouse or directly to the copyright owner depends upon the version of the plug-in the user has installed on his device, how it has been configured, and the business relationship between the copyright owner and the licensing agent. It may also depend upon the owner of the work and the nature of the work the user is requesting to use. The permission request is sent to a server, which directs it according to pre-defined rules contained in a database connected to the server, or routes it to a duly authorized representative for custom handling. The server also sends a verification notice to the user via e-mail that his permission request was received.

Upon receipt of the permissions request form, the licensing agent's server records the receipt of such a request in the article and licensing database, but does not issue a license for the reuse. Instead, it identifies the copyright owner 16 that can handle the request manually. To identify the copyright owner, the licensing agent's server may consult an existing list of works of authorship, could compare the location of the work of authorship to a list of well-known copyright owners, could enlist the assistance of a human researcher to identify the copyright owner for an optional fee, or any other mechanism. Once the copyright owner has been identified, the licensing agent's server emails the request to the appropriate party at the copyright owner 16 to fulfill the user's request.

Records of all interaction with the licensing agent are stored in the article and license database, and are made available to institutions 15 and copyright owners 16 via protected internet sites. The information collected and reported on includes, but is not limited to, such data as the number of times that licensing information for a work of authorship was viewed by users in a particular institution, the number of licenses granted by the licensing agent for a particular work of authorship, the users who were reusing the content, the types of licenses granted, how the works of authorship were reused or redistributed within an institution, who distributed the works of authorship, and so on.

FIG. 2 shows the flow of licensing options for the user. Start at the upper left with step 21, which shows how the installed icon or text link (hot spot) might appear on the user's device.

If the user has received on his device a work of authorship that is not tagged, the flow goes to step 22 where the user can access a ‘Permission Request Form’ by activating the rights icon or text link. This may be done by clicking, touching or voice command. The request is forwarded to a clearinghouse or publisher at step 23.

When the plug-in user mouses over an icon representing the plug-in or otherwise activates the plug-in, the appearance of the icon changes as shown in step 24. At this point, if the work is a compilation of works and contains multiple tags, a drop down menu as shown in step 25 may be displayed or a list of options may be presented verbally. The user can get rights information and/or obtain a license to one or more of the works, or to the complied work.

If the user is covered under a blanket or bulk site licensing agreement and is pre-authorized to use the work according to the terms of that agreement the flow goes to step 26. The plug-in “reads” the tags to determine if the work is covered. Each site-licensing user may have installed a different version of the plug-in, and/or each plug-in can be configured differently, and each site-licensing user may have a site licensing agreement that covers different types of works and specifies different terms and procedures. For example, Boeing may have a site license agreement with a clearinghouse that represents publishers of aviation works. Boeing's version of the plug-in, which they may have installed and properly configured on every employee's computer, may only cover internal photocopying or printing of the tagged works. On the other hand, Disney may have a site license agreement with a different clearinghouse than the one used by Boeing, that represents musicians. Disney's version of the plug-in, which they may have installed on the computers of employees who are animators, may only cover synchronization and performance rights of tagged works. A site license customer may have multiple site-licensing agreements in place with different copyright owners or their authorized clearinghouses.

To find out what type of coverage is in place, and any procedures for complying with the license, the user of the site licensing plug-in can activate the rights icon or text link. This may be done by clicking, touching or voice command. As soon as a tag is located by the plug-in, the plug-in can do a lookup with the server to see if the content can be licensed immediately, in which case it changes its color appropriately: for example, green might mean “This content is covered by your company's site license”, while yellow means “Click to do a one-off license”, and white means “Click for the permissions request form.” Upon activating the link, the following types of information may be displayed:
The copyright owner of the tagged work and the owner's contact information.
The title of the work.
The copyright date of the work.
The distributor of the work.
The name of the organization covered by the site license.
The terminal ID of the user, which may be coded to a certain “seat” or “dept” of that site license customer, such as “marketing,” “administration,” “human resources,” or “executive.” (The reason for having this data is that the organization's site license may only cover certain “seats” or “terminals,” and the organization may be paying a different price for each type of seat.)
A summary of the types of uses covered by the organization's site license. If the type of use desired is not covered by the site license, the user is given instructions on how to request a one-off license.
A link to the full license agreement and contact information for the individual(s) within the organization responsible for managing the site license and copyright compliance in general.
Instructions for complying with the site license agreement.

The instructions given to the user to comply with the site licensing agreement may include, but are not limited to:
Print or make copies of the works using certain internal or external printer or photocopier server gateways, so that the plug-in software can track and report the number of copies made.
Send via certain internal or external e-mail servers, so that the plug-in software can track and report the number of e-mails and their destinations.
Provide publication name and circulation information for republication rights.
Pick from a list of other options that records the selection and quantity.

If no site or bulk license is available, various one-off (individual) licenses may be available, in which case the flow goes to step 27. If the software plug-in user is not covered by a specific site license, or the work being accessed is not covered under a site license agreement, one or more one-off licenses may be presented. These may include, but are not limited to:
Reprints or Photocopies
E-mail Forwarding
Excerpt
E-prints (Intranet or Public Web Site Posting)
Republication
Framing/Linking
Synchronization or Performance
Logo Use
Syndication
Subscription to the Work or Publication

The copyright owner in most cases has pre-authorized these one-off licenses to be offered, by affixing the unique tags to their works and by entering into an appropriate agreement with the licensing agent. The one-off licenses they have pre-authorized may be fee-based or free of charge. They may require the user to supply certain information and to agree to the copyright owner's terms of use agreement. To obtain a license to use the work, the user follows the instructions. When completed, a proof of license is made available to the user or is delivered to the user via e-mail or regular mail or some other mechanism. The licensed version of the work is made available to the user or is delivered to the user via e-mail or regular mail. The user's proof of license is also stored in a database, where the user (licensee) and copyright owner (licensor) or agent can retrieve it.

At the final step, 28, reports may be generated and provided to all parties (licensors, agents, distributors, and licensees). The act of installing and activating the rights icon or text link allows the software plug-in and server hosting the tags to capture certain data, such as:
the number of times a work was accessed
who published the work
who distributed the work
who accessed the work (by user, seat or dept)
what type of license the user obtained
the quantity covered under the license

1. A data carrier carrying a clearance computer program for clearing a previously granted copyright permission which, when run on a user computer connected to a computer network, causes the computer to:
(a) when a rendering program for presenting works retrieved across a network presents a work of authorship, search at least a part of the work of authorship for a tag which identifies the work of authorship;
(b) read an identifier within the clearance program which identifier identifies a class of users by whom the program was authorized to be used; and
(c) if such a tag is found, send across the network to a server having a database of site licenses previously granted a request to search the database for a record for the work of authorship as identified by the tag and search for a record of a permission previously granted for that work for a class of users identified by that program identifier.

2. The data carrier of claim 1 where the searching of the work of authorship for a tag takes place in response to user input provided while the rendering program is presenting the work of authorship.

3. The data carrier of claim 2 where the user input consists of clicking on a hotspot within a user interface for the rendering program.

4. The data carrier of claim 3 where the hotspot includes an icon.

5. The data carrier of claim 1 where the part of the work of authorship that is searched includes metadata for the work.

6. The data carrier of claim 1 where the clearance program is a plug-in for a standard browser program.

7. The data carrier of claim 1 where the permission includes one or more of permission to: reproduce, distribute, perform, display, or prepare a derivative work.

8. The data carrier of claim 1 where the class of users consists of at least one of: employees of a business, educational users, non-profit enterprise employees, and government employees.

9. The data carrier of claim 1 where the clearance program also causes the computer to:
(d) request from the server an indication whether a permission was previously granted for that work for a class of users identified by that clearance program identifier.

10. The data carrier of claim 9 where the program also causes the computer to:
(e) report to a server on the network if the computer is directed by a user to make a use of the work of authorship that falls within the permission.

11. The data carrier of claim 1 where the data carrier is a physical memory.

12. The data carrier of claim 1 where the data carrier is a data carrier signal transmitted on a computer network.

13. A data carrier carrying a cuing computer program for cuing a user that a work of authorship is available for licensed use that, when run on a user computer connected to a computer network, causes the computer to:
(a) when a rendering program presents a work of authorship, independent of user input, search at least a part of the work of authorship for a tag which identifies the work of authorship;
(b) if such a tag is found, independent of user input, send across the network to a server having a database of licenses a request to search the database for a record for the work of authorship as identified by the tag and search for a record of a license for that work; and
(c) if a license is found, independent of user input, provide output at a user interface indicating that a license is available.

14. The data carrier of claim 13 where the license is at least one of: an offer to all to grant a permission to make a use of the work of authorship on stated terms, and a previously granted site license that encompasses the computer on which the cuing program is run.

15. The data carrier of claim 13 where the output is at least one of: a visual change in a display, an auditory event, and a change in the appearance of an icon on a display.

16. The data carrier of claim 13 where the work of authorship is at least one of: a visual work, an auditory work, a video work, a speech work, a music work, a textual work, an image work, and a graphic work.

17. The data carrier of claim 13 where the part of the work of authorship that is searched includes metadata for the work.

18. The data carrier of claim 13 where the cuing program is a plug-in for a standard browser program.

19. The data carrier of claim 13 where the cuing program also causes the computer to:
(f) report to a server on the network if the computer is directed by a user to make a use of the work of authorship that falls within the license.

20. The data carrier of claim 13 where the data carrier is a physical memory.

21. The data carrier of claim 13 where the data carrier is a data carrier signal that is transmitted across a computer network.

22. A method for copyright managers to facilitate the use of site licensing for works of authorship available on computer networks, comprising:
(a) embedding in each of a plurality of works of authorship a tag which identifies the work and making the works available on a computer network;
(b) granting to a company a site license which allows employees of the company to make licensed uses of the works of authorship;
(c) maintaining on a computer network a database of licenses for the works of authorship wherein the tag for each work can be used to find licensing information about the work; and
(d) issuing to the company for installation on computers used by its employees at least one clearance program which, when installed and run, causes a computer to:
(1) when a rendering program presents a work of authorship, search at least a part of the work of authorship for a tag which identifies the work of authorship;
(2) read an identifier within the clearance program which identifier identifies a class of users consisting of company employees by whom the program was authorized to be used; and
(3) if such a tag is found, send across the network to the server a request to search for a record for the work of authorship as identified by the tag and search for a record of a license previously granted for that work for the class of users identified by that program identifier.

23. The method of claim 22 where the searching of the work of authorship for a tag takes place in response to user input provided while the browser program is presenting the work of authorship.

24. The method of claim 23 where the user input consists of clicking on a hotspot within a user interface for the rendering program.

25. The method of claim 24 where the hotspot includes an icon.

26. The method of claim 22 where the part of the work of authorship that is searched includes metadata for the work.

27. The method of claim 22 where the database of licenses comprises at least one of: an offer to all to grant a permission to make a use of the work of authorship on stated terms, and any previously granted site license that encompass the computer on which the clearance program is run.

28. The method of claim 22 where the clearance program is a plug-in for a standard browser program.

29. The method of claim 22 where the clearance program also causes the computer to:
(4) request from the server an indication whether a permission was previously granted for that work for the class of users identified by that clearance program identifier.

30. The method of claim 29 where the clearance program also causes the computer to:
(5) report to a server on the network if the computer is directed by a user to make a use of the work of authorship that falls within the permission.
